(19) United States
(12) Patent Application Publication
(10) Pub. No.: US 2010/0302373 A1
(43) Pub. Date: Dec. 2, 2010

(54) CAMOUFLAGED SURVEILLANCE DEVICES

(76) Inventor: Michael G. Monsive, JR., Cypress, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/476,062

(22) Filed: Jun. 1, 2009

(51) Int. Cl. H04N 7/18

(52) U.S. Cl. 348/151; 348/E07.085

(57) ABSTRACT

Apparatus and systems suitable for discreet surveillance of a remote site or installation are provided. The security system may comprise one or more surveillance units and a main server unit. To facilitate discreet surveillance, the surveillance units may comprise one or more surveillance devices camouflaged by objects or utilities commonly used on the site or installation. Surveillance data collected by these camouflaged surveillance devices may be transmitted by the surveillance units to the main server unit. The main server unit may receive, analyze and/or store the surveillance data and/or results of the analysis. Analysis of the surveillance data may aid in detecting intrusions and/or obtaining intrusion-related information. Security systems comprising such surveillance units may be suitable for a wide variety of applications.

### BACKGROUND OF THE INVENTION

1. Field of the Invention

Embodiments of the present invention generally relate to surveillance systems and, more particularly, to surveillance systems with one or more camouflaged surveillance devices.

2. Description of the Related Art

Security systems have found applications in various areas. Homes, warehouses, retail stores, construction sites, banks, automated teller machines (ATMs), etc., all use security systems. Deployment of security systems may help detect and/or prevent intrusions, theft, vandalism, and other mishaps.

Security systems may be used to monitor remote installations, sites, etc., where vandalism or theft may be common. Such security systems may comprise surveillance devices like cameras, video recorders, and infrared (IR) devices to collect data about the remote installation or site.

### SUMMARY OF THE INVENTION

One embodiment of the present invention provides an apparatus for monitoring a construction site. The apparatus generally includes an object commonly located at the construction site and at least one surveillance device disposed in or on the object such that the surveillance device is camouflaged.

Another embodiment of the present invention provides an apparatus for surveillance. The apparatus generally includes an object fabricated to look like an item associated with a construction site and at least one surveillance device disposed in or on the object such that the surveillance device is camouflaged.

Yet another embodiment of the present invention provides a system for surveillance. The system typically includes a main unit and one or more surveillance units. The main unit generally includes a receiver for receiving signals and a control unit configured to process the received signals. At least one of the surveillance units generally includes an object commonly located at a construction site, at least one surveillance device disposed in or on the object such that the surveillance device is camouflaged, and a transmitter configured to transmit signals from the at least one of the surveillance units for reception by the main unit, the transmitted signals based on data collected by the at least one surveillance device.

### BRIEF DESCRIPTION OF THE DRAWINGS

A more particular description of the invention, briefly summarized above, may be had by reference to the embodiments thereof which are illustrated in the appended drawings. It is to be noted, however, that the appended drawings illustrate only typical embodiments of the invention and are, therefore, not to be considered limiting in its scope, for the invention may admit to other equally effective embodiments.

FIG. 1 illustrates a security system suitable for discreet surveillance in accordance with certain embodiments of the present disclosure.

FIG. 2 illustrates a block diagram of an example surveillance unit in accordance with certain embodiments of the present disclosure.

FIG. 3 illustrates an example main server unit in accordance with certain embodiments of the present disclosure.

### DETAILED DESCRIPTION

Certain embodiments of the present disclosure may provide techniques, apparatus, and a security system suitable for discreet surveillance of a site or installation. The security system may comprise one or more surveillance units and a main server unit. To facilitate discreet surveillance, the surveillance units may comprise one or more surveillance devices camouflaged by objects or utilities commonly used on the site or installation. Surveillance data collected by these camouflaged surveillance devices may be transmitted by the surveillance units to the main server unit. The main server unit may receive, analyze and/or store the surveillance data and/or results of the analysis. Analysis of the surveillance data may aid in detecting intrusions and/or obtaining intrusion-related information. Security systems comprising such surveillance units may be suitable for a wide variety of applications (e.g., prevention of employee theft and monitoring of properties by insurance companies).

### An Example Security System with Camouflaged Surveillance Devices

Conventional security systems deployed in remote sites or installations may not be effective in performing surveillance. This is because surveillance devices constituting such systems may be deployed in a conspicuous manner. An intruder, for example, may therefore become aware of the surveillance devices and may avoid detection by staying clear of the surveillance devices or by disabling these devices. Accordingly, techniques and apparatus that facilitate discreet surveillance of a site or installation may be desirable.

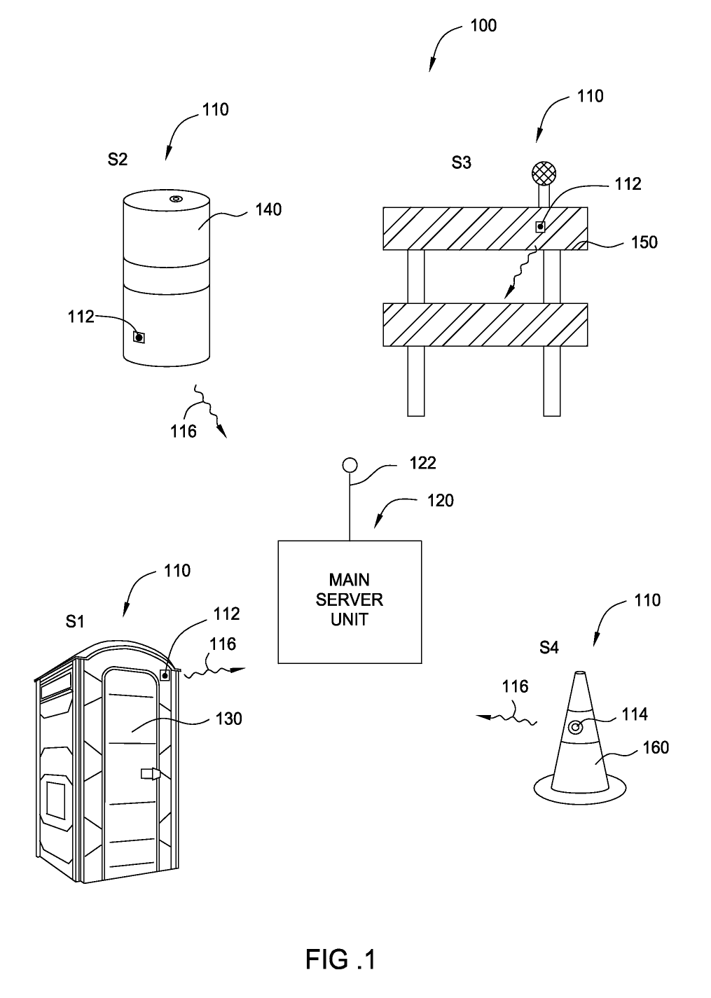

FIG. 1 illustrates a security system 100, which may be deployed at a construction site, for example, according to certain embodiments of the present disclosure. As illustrated in FIG. 1, the security system 100 may comprise one or more surveillance units 110 and a main server unit 120. The surveillance units 110 may facilitate discreet surveillance of the surroundings as described below. For some embodiments, the surveillance units 110 may only be activated after normal working hours (e.g., during nights and weekends). Surveillance data collected by the surveillance units 110 may be transmitted to the main server unit 120 for analysis and/or storage purposes.

To facilitate discreet surveillance of a site or installation, the surveillance units 110 may comprise one or more surveillance devices (e.g., motion sensors, cameras, and audio recorders) camouflaged by objects that are commonly used on the site or installation. Camouflaging of the surveillance devices may be accomplished by inconspicuously positioning the surveillance devices in these objects. As an example, FIG. 1 illustrates example surveillance units S1, S2, S3 and S4 that may be suitable for monitoring a construction site. Surveillance unit S1 comprises a motion sensor 112 camouflaged by a portable toilet 130, also known as a port-o-let or porta-potty, among other names. Similarly, surveillance units S2 and S3 may be fabricated by camouflaging motion sensors 112 using a barrel 140 and a road block 150, respectively. Surveillance unit S4 may comprise a camera 114 camouflaged by a traffic cone 160.

By employing objects that are commonly used on a site for camouflaging, the surveillance devices may have certain advantages. For example, if obviously deployed surveillance devices are present on the site, an intruder may manage to avoid being detected by these devices as described above. On the other hand, camouflaged surveillance devices, such as the surveillance devices illustrated in FIG. 1, may draw less attention due to the mundane nature of the objects camouflaging these devices. As a result, an intruder is less likely to spot and/or disable the camouflaged surveillance devices, and the presence of the intruder is more likely to be detected.

Certain embodiments of the security system 100 may, in addition to the surveillance units 110, include one or more conspicuously deployed surveillance units (e.g., the main server unit 120) comprising one or more surveillance devices. These conspicuously deployed surveillance units may help deter intruders to a certain extent. Intruders who successfully avoid detection by these more conspicuous surveillance units may be more effectively detected by the surveillance units 110.

Depending on the site to be surveyed, the security system 100 may include various combinations of surveillance units similar to the units S1, S2, S3, and S4. For example, a street construction project may only use barrels and traffic cones on-site. Accordingly, surveillance of such a site may be accomplished by employing surveillance units similar to the units S2 and S4. On the other hand, to monitor a building construction site, a surveillance unit similar to the unit S1 may be well-suited since portable toilets are typically present on building construction sites.

For some embodiments, the surveillance units 110 comprising a camouflaged surveillance device may be fully functional. For other embodiments, the surveillance units having the camouflaged device may be non-functional imitations. Employing such non-functional imitations may save manufacturing costs. For example, a non-functional portable toilet 130 with a camouflaged surveillance device may be cheaper to fabricate than a functional portable toilet with the same device.

In certain embodiments, a surveillance unit 110 may comprise one or more surveillance devices camouflaged by an object manufactured to look like one or more bricks or grass sod. Such surveillance units may be well-suited for monitoring residential construction sites from which objects such as bricks or grass sod are prone to be stolen.

Surveillance data collected by the camouflaged surveillance devices may be analyzed for purposes such as detecting intrusions and obtaining intrusion-related information (e.g., seriousness of an intrusion and number of intruders on-site at a given time). The analysis may be done at the main server unit 120 for some embodiments. To facilitate such an analysis, the surveillance units 110 may transmit one or more signals 116 to the main server unit 120. The signals 116 may carry the surveillance data. Means for transmitting the signals 116 may include one or more transmitter antennas. For some embodiments, the antennas may also be camouflaged in an effort to facilitate discreet surveillance. The main server unit 120 may comprise one or more receivers 122 for receiving the signals 116, as illustrated in FIG. 1. The main server unit 120 may comprise means for analyzing the received surveillance data, as will be described below.

Analyzing the surveillance data at the main server unit 120 may have certain advantages. For example, by delegating complex data analysis operations to the main server unit 120, a surveillance unit 110 may be made structurally and/or functionally simple. Construction costs of such surveillance units may therefore decrease, and the surveillance units may consume less power. Furthermore, instead of locally storing the data collected by individual surveillance units 110, the data may be centrally stored at the main server unit 120, thereby reducing costs associated with providing memory and/or data storage equipment for each surveillance unit 110.

Certain embodiments of the present disclosure may not include a main server unit 120. Such embodiments may comprise means for facilitating exchange of surveillance data among the surveillance units 110. Such means may comprise one or more transmitter antennas and/or receiver antennas. One or more of these surveillance units 110 may comprise means for performing complex and/or simple analysis operations on the surveillance data received from the other surveillance units 110. In other words, such surveillance units 110 may be responsible for the analysis operations that the main server unit 120 may perform, if present. The surveillance units may also comprise means for storing the surveillance data and/or results of the analysis.

For some embodiments, one or more surveillance units 110 or the main server unit 120 may send an e-mail, text message (Short Message Service, or SMS), or a paging notification to a remote site, personal computer (PC), server, or mobile device when an intrusion is detected. This message may include a video and/or one or more camera snapshots of the monitored site starting from when the intrusion was detected or shortly thereafter. In some embodiments, components of the security system 100 may include global positioning system (GPS) tracking for increased functionality and traceability.

### An Example Surveillance Unit

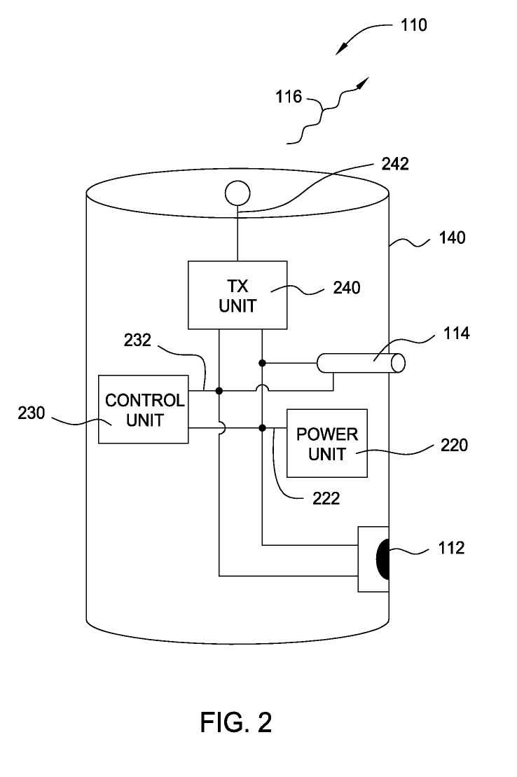

FIG. 2 illustrates an example surveillance unit 110, in accordance with certain embodiments. In the example illustrated, one or more motion sensors 112 and one or more cameras 114 may be used as surveillance devices. However, any of various suitable devices such as motion sensors, cameras, and audio recorders may be used, alone or in combination, as surveillance devices. Certain embodiments may include surveillance devices suitable for use in harsh environments involving high humidity and/or extreme temperatures. These surveillance devices, along with other components of the surveillance unit 110, may be camouflaged by an object typically found at the site where the surveillance devices are to be deployed, such as the barrel 140 illustrated in FIG. 1. Exposed portions of the surveillance devices may be painted, or otherwise fabricated to match the portions of the object where these devices will be positioned.

In some embodiments, the motion sensors 112 may be active sensors that are capable of detecting motion in the surroundings by releasing energy (e.g., optical and acoustical). For example, if a motion sensor 112 releases optical energy, motion detection may be performed as follows. The optical energy released by the motion sensor 112 may be reflected by nearby objects and then travel back to the motion sensor 112. The amount of energy thus received by the motion sensor 112 may typically remain constant. However, when there is a foreign presence (e.g., an intruder), static or moving, within the field of the motion sensor 112, the energy travelling back to the sensor 112 may be disrupted or otherwise altered, thereby causing a change in the amount of energy received by the sensor 112. The change in received energy may indicate motion in the surroundings. In other embodiments, the motion sensors 112 may be passive sensors, such as a passive infrared (PIR) sensor. A PIR sensor may be capable of detecting motion by continuously, periodically, or intermittently collecting infrared energy emitted by surrounding objects and analyzing the collected energy for anomalies caused by any foreign presence. In this manner, the motion sensors 112 may aid in detecting unexpected or unauthorized motion or intrusion.

Deploying the motion sensors 112 in objects may not always be effective in preventing the objects themselves from being stolen. For example, an attempt to steal such an object may involve lifting the object from above, using a lifting device, such as a winch. Such attempts may go undiscovered if the motion sensor 112 positioned in the object is not able to notice the approaching lifting device due to the device falling beyond the range of the motion sensor 112. Certain embodiments of the surveillance units 110 may overcome this limitation by incorporating means for detecting vibrations in the surroundings. Means for detecting vibrations may include one or more vibration sensors. By sensing vibrations in the surroundings, an approaching lifting device may be detected based on the vibrations caused by the lifting device, since these vibrations may be significantly greater than the vibrations normally present in the surroundings.

A variety of cameras may be used as camouflaged surveillance devices in the surveillance units 110. For example, the cameras 114 may be fixed cameras with zooming capabilities, built-in infrared (IR) for nighttime imaging, or a combination thereof. In some embodiments of the surveillance units 110, cameras 114 with panning/tilting/zooming (PTZ) capabilities may be used as surveillance devices. The motion sensors 112, the cameras 114, and/or other surveillance devices (e.g., sound recorders), if present, may operate simultaneously and continuously, or at least periodically, to collect surveillance data. However, in some embodiments, certain surveillance devices, such as the cameras 114 and sound recorders, may be activated in response to the motion sensors 112 detecting motion in the surroundings, so that information (e.g., in the form of pictures, video, and/or audio recordings) about the cause of motion may be collected.

Surveillance data collected by the motion sensors 112 and/or the other surveillance devices may be transmitted to the main server unit 120 for analysis, as described above. This may be accomplished by employing a transmitter unit 240 that comprises one or more transmitter antennas 242. Exposed portions of the antennas 242 may be camouflaged by painting, or otherwise fabricating these portions to match the portions of the object where the antennas 242 are exposed. The transmission may be performed via any of various suitable communication standards or technologies. For example, some embodiments of the present disclosure may include high speed cellular, General Packet Radio Service (GPRS), Enhanced Data rates for Global Evolution (EDGE), satellite, Wi-Fi, WiMAX (Worldwide Interoperability for Microwave Access), mesh, and/or local area network (LAN) capabilities, which, the transmitter unit 240 may utilize for communication purposes. When data becomes available for transmission, the antennas 242 may transmit the data via signals 116. For embodiments that do not include the main server unit 120 as described above, the transmitter unit 240 may be employed for transmitting the surveillance data to other surveillance units 110 for analysis.

For some embodiments, surveillance data collected by the motion sensors 112 and/or other surveillance devices may first be buffered at a control unit 230 before being transferred to the transmitter unit 240. Buffering the information at the control unit 230 may help prevent the transmitter unit 240 from being overwhelmed, thereby improving transmission quality. The control unit 230 may also comprise means for locally storing the surveillance data collected by the motion sensors 112 and the other surveillance devices, for later retrieval. The means for locally storing the surveillance data may comprise any of various suitable storage devices, such as a hard disk, magnetic tape, Random Access Memory (RAM), and flash memory. The collected data may be transferred to the control unit 230 via one or more signal cables 232.

The control unit 230 may further include means for activating the other surveillance devices (e.g., cameras and sound recorders) based on motion detection results obtained from the motion sensors 112. Such means may comprise one or more devices, such as a processor or microcontroller, capable of detecting intrusion alerts contained in the motion detection results and, in response, activating the other surveillance devices with a trigger signal. Such means may also be employed for controlling the operations of the various surveillance devices including the motion sensors 112. For example, if cameras 114 with PTZ capabilities are used, the control unit 230 may manipulate the panning, tilting, and/or zooming of the cameras 114. To perform such control operations, the control unit 230 may issue one or more control signals. These control signals may be output from the control unit 230 to the various surveillance devices via the signal cables 232. For some embodiments, one or more control signal cables, separate from the signal cables 232, may be used for this purpose.

In some embodiments, the control unit 230 may filter the surveillance data obtained from the motion sensors 112 and/or the other surveillance devices, before the surveillance data is output to the transmitter unit 240. The control unit 230 may do so based on preliminary analysis of the surveillance data. Based on the preliminary analysis, the control unit 230 may decide not to send any information that the main server unit 120 may not find useful in determining conditions in the surroundings. Means for performing such a preliminary analysis may include any of various suitable processing devices (e.g., sound processors and image processors). In certain embodiments, the analysis operations may be performed by a unit separate from the control unit 230. This unit may also be responsible for the activation of the other surveillance devices. In such embodiments, the control unit 230 may simply perform the buffering and/or storing of data as described above. For embodiments that do not include the main server unit 120 as described above, the means for performing the preliminary analysis may include augmented capabilities to accomplish the analysis operations performed by a main server unit 120, if present. In such embodiments, the means for locally storing the surveillance data as described above may also be augmented so that surveillance data from other surveillance units 110 and/or results of the analysis may be stored, as well.

The various components of the surveillance unit 110 may be powered using an internal power unit 220. The power unit 220 may provide power to the surveillance devices and the rest of the surveillance unit 110 via one or more power cables 222. For some embodiments, the power unit 220 may comprise means for receiving power from one or more external power sources (e.g., power from power lines of an electric grid, stepped down by a transformer). Such means may comprise arrangements, such as an electrical socket, capable of electrically connecting the power unit 220 and an external power source. In other embodiments, the power unit 220 may comprise one or more batteries that may act as a stand-alone power source, or may be used together with power from external power sources for powering the surveillance unit 110.

In certain embodiments, rechargeable batteries may be utilized for powering the components of the surveillance unit 110. Any of various types of rechargeable batteries may be used for this purpose. For example, the rechargeable batteries may be gel batteries (also known as gel cells), which contain battery acid in a gel form. For some embodiments, the rechargeable batteries may be other types of lead-acid batteries, such as absorbent glass mat (AGM) lead-acid batteries. If these rechargeable batteries are not able to sufficiently power the components of the surveillance unit 110, due to a drop in power levels, the batteries may be taken out of the surveillance unit 110, charged, and placed back in the unit 110. The batteries may be fully charged, or at least charged enough to be able to provide sufficient power to the surveillance unit 110.

### An Example Main Server Unit

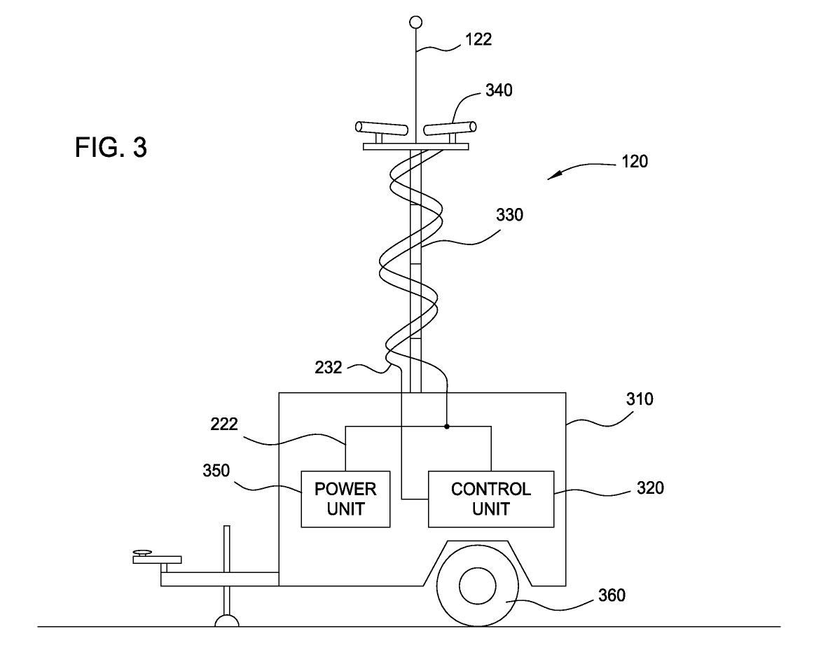

FIG. 3 illustrates an example main server unit 120. As described above, the main server unit 120 may receive, analyze and/or store surveillance data received from the surveillance units 110. The main server unit 120 may also store results of the analysis. Based on the results of the analysis, the main server unit 120 may take one or more suitable actions as described in greater detail below.

As illustrated in FIG. 3, in addition to one or more receivers 122, the main server unit 120 may comprise a base unit 310. The base unit 310 may act as a shield protecting one or more of the components of the main server unit 120 from dust, water, and the like. For some embodiments, the base unit 310 may comprise metal in an effort to shield the internal components from electromagnetic (EM) radiation. Some embodiments of the main server unit 120 may also comprise one or more local surveillance devices 340.

One or more components of the main server unit 120 may be similar, in structure and/or function, to the components of the surveillance unit 110. For example, the local surveillance devices 340 may be similar to the surveillance devices of the surveillance unit 110. Accordingly, devices such as motion sensors, cameras, and sound recorders, with various capabilities as described above may be used as local surveillance devices 340. The base unit 310 of the main server unit 120 may comprise a power unit 350 and a control unit 320, which may be similar to the power unit 220 and the control unit 230 of the surveillance unit 110 in certain embodiments. The main server unit 120 may comprise one or more signal and power cables that are similar to the signal cables 232 and power cables 222 of the surveillance unit 110.

As described above, the main server unit may receive surveillance data from the surveillance units 110 via the receivers 122. Any of various suitable communication standards or technologies, such as those described above for the surveillance unit 110, may be utilized for receiving the surveillance data. Depending on the communication standard or technology, in some embodiments, the main server unit 120 may include state-of-the-art communication capabilities (e.g., acknowledging correct reception of data and requesting retransmission if the data was not properly received). The received data may be transferred to the control unit 320 via the signal cables 232 for analysis.

The control unit 320 of the main server unit 120 may include augmented capabilities when compared to the control unit 230 of the surveillance unit 110. Such capabilities may enable the control unit 320 to handle large volumes of data received from a plurality of surveillance units 110 and to perform complex analysis operations on the received data. As an example, one such analysis operation may comprise determining the seriousness of an intrusion, based on the number of occurrences of motion on the site. If this number exceeds a certain threshold, for example, the control unit 320 may determine that the threat of intrusion is serious.

The control unit 320 may act based on the results of such analysis operations. For example, if an intrusion is suspected, or if it is determined that an intrusion is serious, the control unit 320 may choose to activate one or more alarms (silent or audible) included in the main server unit 120. For some embodiments, the control unit 320 may activate one or more remote alarms that may be mounted away (e.g., at a remote monitoring station) from the rest of the security system 100. For some embodiments, the control unit 320 may trigger a flood light or spot light to turn on in an effort to deter trespassers. For embodiments that do not include the main server unit 120 as described above, activation of the alarms, lights, or sirens may be performed by one or more surveillance units 110 performing such analysis on the surveillance data.

In some embodiments, when an intrusion or any other undesirable activity is suspected, in addition to, or instead of, activating the sirens, lights, or remote alarms, the control unit 320 may signal the local surveillance devices 340, via the signal cables 232, to collect additional data about the location or the cause of the intrusion. This may be particularly useful if the surveillance units 110 primarily rely on motion sensors for collecting surveillance data. A flood light or spot light, if activated as described above, may assist cameras constituting the local surveillance devices 340 with imaging, especially at night. The information thus collected by the local surveillance devices 340 may be sent to the control unit 320 via the signal cables 232 for analysis, as well. For some embodiments, one or more data cables separate from the signal cables 232 may be used for this purpose.

Certain embodiments of the present disclosure may provide means for supporting the local surveillance devices 340 at a desired height above the base unit 310 in an effort to offer a clear or unobstructed view of a large surveillance area. For example, a mast or a pole, such as the pole 330 in FIG. 3, may support the local surveillance devices 340 when mounted on the base unit 310. The pole 330 may be removable from or statically mounted on the base unit 310. For some embodiments, the pole 330 may have a fixed length. For other embodiments, the pole 330 may be a telescoping structure allowing the height of the local surveillance devices 340 to be adjusted. For example, a galvanized three-section telescoping pole with adjustable height (e.g., from 6 feet to 25 feet, or 1.83 m to 7.62 m) may be used. Means for telescoping the pole 330 may include any of various suitable components for adjusting the height of the pole 330, such as electric winches, air cables, manual winches, or a twist lock. For example, the height of the pole 330 may be adjusted using a dual winch system. For some embodiments of the main server unit 120, an eyelet may be included for raising the pole 330.

Some embodiments may comprise means for raising, lowering, or otherwise positioning the pole 330. For example, a hinge mechanism may be provided to allow the pole 330 to rotate between an approximately upright position for surveillance and a fully or at least a more prone position for transportation. For other embodiments, the pole 330 may not be hinged. For such embodiments, the pole 330 may be stepped in a block or other fixture on the base unit 310 in an effort to conduct surveillance. When the local surveillance devices 340 are not in use, the pole 330 may be dismounted (i.e., removed from the block or other such fixture) and lowered to facilitate transportation and/or deployment. In embodiments that do not include the pole 330, the receivers 122 may simply be mounted to or part of the base unit 310.

Some embodiments of the main server unit 120 may include means for transmitting data collected from the surveillance units 110 and/or results of the analysis performed by the control unit 320, to a remote unit (not shown) (e.g., remote servers, PCs, and workstations). For example, mechanisms such as antennas, transmitters may be used to achieve this. Doing so may facilitate further analysis and/or monitoring at a remote location. Any of various suitable communication standards or technologies, such as those previously described for the transmitter unit 240 of the surveillance unit 110, may be employed by the main server unit 120 to transmit data to the remote unit. For embodiments that do not include the main server unit 120 as described above, one or more surveillance units 110 may transmit the surveillance data and/or results of the analysis to the remote unit.

One or more components of the main server unit 120 may be powered by a power unit 350. Similar to the power unit 220 of the surveillance unit 110, the power unit 350 may comprise means for receiving power from one or more external power sources, and/or one or more batteries for providing power to the components of the main server unit 120.

Certain embodiments of the power unit 350 may comprise a chargeable power source, a charging power source, and one or more components for controlling charging of the chargeable power source. The chargeable power source may be configured to power the components of the main server unit 120. The chargeable power source may be any of various suitable devices capable of being repeatedly recharged and supplying sufficient power to the various components. In some embodiments, the chargeable power source may comprise one or more rechargeable batteries, such as the batteries described above, for the power unit 220 of the surveillance unit 110. The terminals of the chargeable power source may be connected with the local surveillance devices 340, the control unit 320, and the receivers 122 via the power cables 222 in an effort to provide power to these components.

The charging power source may provide means for charging the chargeable power source. The charging power source may comprise any of various suitable power sources, such as generators, that may convert mechanical energy into electrical energy, and solar cells that may convert solar energy into electrical energy, used alone or in combination. For some embodiments, the charging power source may comprise an engine driving an alternator to charge the chargeable power source, similar to the engine/alternator/battery combination in a modern automobile. For other embodiments, the charging power source may comprise an engine-generator set (gen-set), which is the combination of an engine driving an electrical generator. The engine of the gen-set may comprise a diesel engine or an internal combustion engine (ICE) using any suitable fuel source, such as gasoline. The engine may comprise a single-cylinder or multiple cylinders and may be liquid-cooled or air-cooled. In addition to the engine and alternator, such a charging power source may include a fuel tank, an engine speed regulator, an alternator voltage regulator, cooling and exhaust systems, and a lubrication system. In the embodiments of charging power sources having an engine described above, the chargeable power source or a separate source (e.g., a battery) may provide power to a starter motor for powering on the engine.

For still other embodiments, the charging power source may comprise a gas engine generator (GEG) where the mechanical energy powering the electrical generator is heat energy from the burning of a gas. For example, the gas burned in a GEG may be natural gas or propane (liquid or gas).

As the efficiency of solar cells continues to improve, the charging power source may comprise one or more solar panels in some embodiments. Each solar panel may comprise several solar cells and may be mounted on an upper or angled lateral surface of the main server unit 120.

In some embodiments of the present disclosure, the main server unit 120 may comprise means to facilitate transportation and/or deployment of the main server unit 120. For example, a trailer assembly with wheels 360 as depicted in FIG. 3 may be used. Such a trailer assembly may comprise any of various suitable components for transporting and/or operating the main server unit 120. These may include any combination of the following: rear outriggers, a tongue jack, a lifting eye, taillights, and the like. Some embodiments may use a sturdy trailer assembly that may be operational in wind gusts up to about 65 mph (104.6 kilometers per hour). For example, the trailer assembly may comprise rear outriggers for stabilizing the structure during strong wind gusts or when placed on an uneven surface.

Some embodiments may include means for transporting and/or deploying the main server unit 120 in a wheel-less manner. These means may include arrangements such as skids, skis or sleds, and legs. Such means may facilitate transportation and/or deployment of the main server unit 120 in areas not accessible by roads, such as those covered by ice or snow or areas located in a body of water.

In certain embodiments, the surveillance units 110 may comprise one or more electromagnetic sources, which are capable of constantly emitting beams of radiation that are invisible to the naked eye. These beams may be used to detect unexpected or unauthorized motion in the surroundings by including at the main server unit 120, devices capable of measuring the energy of the beams. Such devices may comprise one or more electromagnetic sensors. When such a beam has a line-of-sight path between the electromagnetic source at the surveillance unit 110 emitting the beam and an electromagnetic sensor at the main server unit 120, breaking of the beam by an intruder, for example, may change the energy received by the sensor, thereby revealing the intruder's presence. Based on this technique, when an intrusion is detected, the control unit 230 may trigger one or more alarms, turn on one or more lights, or activate the local surveillance devices 340 as described above. The electromagnetic sources may assist existing surveillance devices of the surveillance units 110. In certain embodiments of the surveillance units 110, the existing surveillance devices may be entirely replaced by the electromagnetic sources. The resulting surveillance units 110 may not offer the same advantages in terms of surveillance. However, costs associated with construction and maintenance of the surveillance units 110 may decrease, thereby facilitating cost-effective surveillance.

While the foregoing is directed to embodiments of the present invention, other and further embodiments of the invention may be devised without departing from the basic scope thereof, and the scope thereof is determined by the claims that follow.

1. An apparatus for monitoring a construction site, comprising:
an object commonly located at the construction site; and
at least one surveillance device disposed in or on the object such that the surveillance device is camouflaged.

2. The apparatus of claim 1, wherein the surveillance device is painted or fabricated to match a portion of the object where the device is positioned.

3. The apparatus of claim 1, wherein the object comprises at least one of a traffic cone, a road block, or a barrel.

4. The apparatus of claim 1, wherein the object comprises a portable toilet.

5. The apparatus of claim 1, wherein the surveillance device comprises a motion sensor.

6. The apparatus of claim 1, wherein the surveillance device comprises a camera.

7. An apparatus for surveillance, comprising:
an object fabricated to look like an item associated with a construction site; and
at least one surveillance device disposed in or on the object such that the surveillance device is camouflaged.

8. The apparatus of claim 7, wherein the surveillance device is painted or fabricated to match a portion of the object where the device is positioned.

9. The apparatus of claim 7, wherein the object is fabricated to look like one or more bricks or grass sod.

10. The apparatus of claim 7, wherein the object is fabricated to look like a portable toilet.

11. The apparatus of claim 7, wherein the surveillance device comprises a motion sensor.

12. The apparatus of claim 7, wherein the surveillance device comprises a camera.

13. A system for surveillance, comprising:
a main unit, comprising:
a receiver for receiving signals; and
a control unit configured to process the received signals; and
one or more surveillance units, wherein at least one of the surveillance units comprises:
an object commonly located at a construction site;
at least one surveillance device disposed in or on the object such that the surveillance device is camouflaged; and
a transmitter configured to transmit signals from the at least one of the surveillance units for reception by the main unit, the transmitted signals based on data collected by the at least one surveillance device.

14. The system of claim 13, wherein the main unit comprises local surveillance equipment, such that the control unit is configured to process signals from the local surveillance equipment and the signals received by the receiver.

15. The system of claim 14, wherein the local surveillance equipment is mounted on a pole of the main unit.

16. The system of claim 15, wherein the pole of the main unit is a telescoping pole.

17. The system of claim 13, wherein the transmitter is configured to transmit the signals from the at least one of the surveillance units using at least one of high speed cellular, General Packet Radio Service (GPRS), Enhanced Data rates for Global Evolution (EDGE), satellite, Wi-Fi, or WiMAX (Worldwide Interoperability for Microwave Access).

18. The system of claim 13, wherein the at least one surveillance device is painted or fabricated to match a portion of the object where the device is positioned.

19. The system of claim 13, wherein the object comprises at least one of a traffic cone, a road block, a barrel, or a portable toilet.

20. The system of claim 13, wherein the at least one surveillance device comprises at least one of a motion sensor or a camera.
